(19) United States
(12) Patent Application Publication
(10) Pub. No.: US 2021/0080775 A1
(43) Pub. Date: Mar. 18, 2021

(54) CHIP TEMPERATURE CONTROL CIRCUIT OF LIQUID CRYSTAL DISPLAY PANEL AND LIQUID CRYSTAL DISPLAY PANEL

(71) Applicant: SHENZHEN CHINA STAR OPTOELECTRONICS TECHNOLOGY CO., LTD., Shenzhen, Guangdong (CN)

(72) Inventors: Wenfang LI, Shenzhen, Guangdong (CN); Xianming ZHANG, Shenzhen, Guangdong (CN); Dan CAO, Shenzhen, Guangdong (CN)

(21) Appl. No.: 16/080,208

(22) PCT Filed: Jun. 12, 2018
(86) PCT No.: PCT/CN2018/090855

§ 371 Date: Aug. 27, 2018

(30) Foreign Application Priority Data
Apr. 17, 2018 (CN) 201810343761.5

(51) Int. Cl. G02F 1/1333; G09G 3/36

(52) U.S. Cl. CPC G02F 1/133382; G09G 3/3611; G09G 2320/043; G09G 2330/021; G09G 2310/08; G09G 2330/045

(57) ABSTRACT

Disclosed is a chip temperature control circuit of a liquid crystal display panel, comprising a chip, the temperature of the chip increasing with the increase of power consumption; a thermosensitive element positioned on the chip, the electrical characteristic of thermosensitive element changing in response to change in the temperature of the chip; an analog-to-digital converter which is electrically connected to both ends of the thermosensitive element to obtain an analog voltage signal of the thermosensitive element, the analog-to-digital converter converting the analog voltage signal into a corresponding digital voltage signal; a timing controller which is electrically connected to an output of the analog-to-digital converter and the chip respectively, the timing controller obtaining a corresponding chip temperature according to the digital voltage signal obtained and adjusting the chip to reduce power consumption when the temperature of the chip exceeds a predetermined temperature. The invention also discloses a liquid crystal display panel.

### RELATED APPLICATION

The present application claims the priority of China Application No. 201810343761.5, entitled “CHIP TEMPERATURE CONTROL CIRCUIT OF LIQUID CRYSTAL DISPLAY PANEL AND LIQUID CRYSTAL DISPLAY PANEL”, filed on Apr. 17, 2018, the disclosure of which is incorporated herein by reference in its entirety.

### FIELD OF THE INVENTION

The present invention relates to a display technology field, in particular to a chip temperature control circuit of a liquid crystal display panel and a liquid crystal display panel.

### BACKGROUND OF THE INVENTION

As the technology of thin film transistor liquid crystal display panel (TFT LCD) becomes increasingly mature, TV, computer and other products require the size of the liquid crystal display panel to gradually increase, the resolution of the liquid crystal display panel is also increasingly high, and the power consumption of the corresponding liquid crystal display panel is also increasing, resulting in high power consumption of the chip in the liquid crystal display panel. For example, the chip is a PMIC (Power Management IC), a source driver integrated chip, or the like. The temperature of the chip is also getting high, and the high temperature will shorten the service life of the chip.

### SUMMARY OF THE INVENTION

The technical problem to be solved by the embodiments of the present invention is to provide a chip temperature control circuit of a liquid crystal display panel and a liquid crystal display panel, which can prolong the life of the liquid crystal display panel.

In order to solve the technical problem described above, an embodiment of the first aspect of the present invention provides a chip temperature control circuit, comprising:
a chip, the temperature of the chip increasing with the increase of power consumption;
a thermosensitive element positioned on the chip, the electrical characteristic of thermosensitive element changing in response to change in the temperature of the chip;
an analog-to-digital converter which is electrically connected to both ends of the thermosensitive element to obtain an analog voltage signal of the thermosensitive element, the analog-to-digital converter converting the analog voltage signal obtained into a corresponding digital voltage signal;
a timing controller which is electrically connected to an output of the analog-to-digital converter and the chip respectively, the timing controller obtaining a corresponding chip temperature according to the digital voltage signal obtained, and the timing controller adjusting the chip to reduce power consumption when the temperature of the chip exceeds a predetermined temperature.

In the embodiment of the first aspect of the present invention, the thermosensitive element is a PN junction, and the voltage between the both ends of PN junction changes in response to change in the temperature of the chip.

In the embodiment of the first aspect of the present invention, the thermosensitive element is a thermosensitive resistor, and the resistance value of thermosensitive resistor changes in response to change in the temperature of the chip.

In the embodiment of the first aspect of the present invention, the thermosensitive element is also electrically connected to a power source to form a closed loop.

In the embodiment of the first aspect of the present invention, the power source is a current source or a voltage source, and the loop also comprises a second resistor connected in series with the thermosensitive element.

In the embodiment of the first aspect of the present invention, a correspondence table indicating a correspondence relationship between a digital voltage signal range and a chip temperature is stored in the timing controller, and the timing controller can specify a corresponding temperature of the chip according to the digital voltage signal received and the correspondence table.

In the embodiment of the first aspect of the present invention, the chip comprises a substrate and an electronic component positioned on the substrate, and the thermosensitive element is positioned on the substrate, and the electronic component is disposed around the thermosensitive element.

In the embodiment of the first aspect of the present invention, the chip is a power management integrated chip, a source driver integrated chip or a gate driver integrated chip, or, the chip comprises a power management integrated chip and a driver integrated chip, and the thermosensitive elements are respectively arranged on the power management integrated chip and the driver integrated chip, and the thermosensitive elements are electrically connected to the analog-to-digital converter respectively.

In the embodiment of the first aspect of the present invention, the timing controller reduces the operating frequency of the chip when the temperature of the chip exceeds the predetermined temperature.

An embodiment of the second aspect of the present invention provides a liquid crystal display panel comprising the chip temperature control circuit of the liquid crystal display panel described above.

Embodiments of the present invention have following beneficial effects.

The thermosensitive element is positioned on the chip, and changes its electrical characteristic in response to the change in the temperature of the chip. The analog-to-digital converter is electrically connected to both ends of the thermosensitive element, and obtains the analog voltage signal of the thermosensitive element and converts the analog voltage signal obtained into the corresponding digital voltage signal. The timing controller is electrically connected to the output of the analog-to-digital converter and the chip respectively, and the timing controller obtains a corresponding chip temperature according to the digital voltage signal obtained, and adjusts the chip to reduce power consumption when the chip temperature exceeds a predetermined temperature. Therefore, the temperature of the chip can be controlled and not too high, so the service life of the chip will not be shortened, similarly, the service life of other components will not be shortened, thereby prolonging the service life of the liquid crystal display panel.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other obvious various embodiments according to these figures without paying the premise.

FIG. 1 is a schematic diagram of a chip temperature control circuit of a liquid crystal display panel according to a first embodiment of the present invention;

FIG. 2 is a schematic diagram of a chip temperature control circuit of a liquid crystal display panel according to a second embodiment of the present invention;

### REFERENCE SIGNS

110—chip; 111—PN junction; 120—decoder; 121—analog-to-digital converter (ADC); 130—timing controller (Tcon); 210—power management integrated chip; 310—driver integrated chip.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

The terms “comprising” and “having” and any deformations thereof appearing in the specification, the claims, and the drawings are intended to cover non-exclusive inclusion. For example, a process, a method, a system, a product or a device comprising a series of steps or units which is not limited to the steps or units already listed, but optionally further comprises steps or units which are not listed, or optionally further comprises other steps or units which are inherent in these the process, the method, the product or the device. The terminologies “first”, “second” and “third” are used for distinguishing different objects but not for describing the specific sequence.

### First embodiment

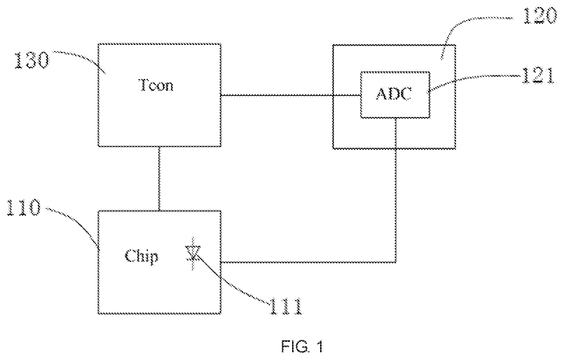

Please refer to FIG. 1, a first embodiment of the present invention provides a chip temperature control circuit of a liquid crystal display panel, which comprises a chip 110, a thermosensitive element, an analog-to-digital converter 121, and a timing controller 130.

In this embodiment, the temperature of the chip 110 increases with the increase of power consumption. In this embodiment, the chip 110 is positioned outside the array substrate of the liquid crystal display panel, and the chip 110 is electrically connected to a circuit on the array substrate through a flexible circuit board or other circuits. In this embodiment, the chip 110 comprises a substrate and an electronic component positioned on the substrate, In this embodiment, the chip 110 is a power management integrated chip (PMIC), a source driver integrated chip or a gate driver integrated chip.

In this embodiment, the thermosensitive element is positioned on the chip 110, and detects the temperature of the chip 110 at any time, and the thermosensitive element changes its electrical characteristic in response to change in the temperature of the chip 110, such as changing its resistance characteristic or voltage characteristic. When the resistance characteristic is changed, the resistance value of the thermosensitive element changes in response to change in temperature, and when the voltage characteristic is changed, the voltage between the both ends of the thermosensitive element changes in response to change in temperature. In this embodiment, the thermosensitive element is a PN junction 111, and the RN junction 111 is positioned on the chip 110, specifically on the substrate of the chip 110. The PN junction 111 changes its voltage between the both ends of the PN junction 111 in response to change in the temperature of the chip 110. In addition, in other embodiments of the present invention, the thermosensitive element may also be a thermosensitive resistor, and the thermosensitive resistor is positioned on the chip, specifically on the substrate of the chip. The thermosensitive resistor changes its resistance value in response to change in the temperature of the chip.

In this embodiment, the analog-to-digital converter 121 is electrically connected to both ends of the thermosensitive element, and obtains the analog voltage signal of the thermosensitive element by detecting the voltage between the both ends of the thermosensitive element, and converts the analog voltage signal obtained into a corresponding digital voltage signal. In this embodiment, the liquid crystal display panel comprises a decoder 120, and the decoder 120 comprises the analog-to-digital converter 121. Therefore, the existing decoder 120 of the liquid crystal display panel can be utilized, and it is not necessary to additionally add the analog-to-digital converter 121, so that the cost can be reduced.

In this embodiment, the timing controller 130 is electrically connected to an output of the analog-to-digital converter 121 and the chip 110 respectively. The timing controller 130 obtains a corresponding chip temperature according to the digital voltage signal obtained, and determines whether the chip temperature exceeds a predetermined temperature. The predetermined temperature is already set in advance. When the timing controller 130 determines that the chip temperature exceeds the predetermined temperature, the timing controller 130 adjusts the chip 110 to reduce power consumption, thereby lowering the temperature of the chip 110. In this embodiment, the timing controller 130 reduces the power consumption of the chip 110 mainly by adjusting an operating frequency of the chip 110, but the invention is not limited thereto. In other embodiments of the invention, the timing controller can also reduce the power consumption of the chip by adjusting some electronic components on the chip to work and some electronic components on the chip not work. Additionally, in other embodiments of the invention, the timing controller can also reduce the power consumption of the chip by adjusting other parameters of the chip, such as adjusting the reverse mode, or the like.

In this embodiment, in order to obtain the corresponding chip temperature according to the digital voltage signal, a correspondence table indicating a correspondence relationship between a digital voltage signal range and a chip temperature is stored in the timing controller 130, the timing controller 130 can obtain the current chip temperature by looking up the table according to the digital voltage signal received, and can further determine whether the chip temperature exceeds a predetermined temperature. The following table gives an example of the correspondence table indicating the correspondence relationship between the digital voltage signal range and the chip temperature.

| Digital voltage signal | chip |
|---|---|
| range | temperature |
| (0.01 V, 0.05 V] | 40° |
| (0.05 V, 0.1 V] | 41° |
| (0.1 V, 0.2 V] | 42° |

For example, when the digital voltage signal received by the timing controller 130 is 0.05V, the timing controller 130 looks up the table and finds that the digital voltage signal of 0.05V falls within the range of (0.01V, 0.05V], thereby obtaining the current chip temperature which is 40 degrees.

In this embodiment, the predetermined temperature may be a preset value or a plurality of preset values. When the predetermined temperature is a plurality of preset values, the timing controller 130 may perform different processing procedures in response to the chip temperature exceeding different predetermined temperatures, for example, the corresponding frequency is different after the adjustment.

In this embodiment, the thermosensitive element is positioned on the chip 110, and changes its electrical characteristic in response to the change in the temperature of the chip 110. The analog-to-digital converter 121 is electrically connected to both ends of the thermosensitive element, and obtains the analog voltage signal of the thermosensitive element and converts the analog voltage signal obtained into a corresponding digital voltage signal. The timing controller 130 is electrically connected to an output of the analog-to-digital converter 121 and the chip 110 respectively, and the timing controller 130 obtains a corresponding chip temperature according to the digital voltage signal obtained, and adjusts the chip 110 to reduce power consumption when the chip temperature exceeds a predetermined temperature. Therefore, the temperature of the chip can be controlled and not too high, so the service life of the chip 110 will not be shortened, similarly, the service life of other components will not be shortened, thereby prolonging the service life of the liquid crystal display panel.

In order to make the change of the electrical characteristic of the thermosensitive element accurately reflect the change of the chip temperature, in this embodiment, the electronic component on the chip 110 is disposed around the thermosensitive element, so the thermosensitive element is close to the electronic component, so that when the electronic component on the chip 110 gives out heat, the temperature change of the chip 110 can be accurately detected.

Additionally, in other embodiments of the invention, the thermosensitive element is a thermosensitive resistor. The thermosensitive resistor needs to be electrically connected to a power source to form a closed loop. Thus, the analog-to-digital converter is electrically connected to both ends of the thermosensitive resistor to obtain an analog voltage signal of the thermosensitive resistor. In other embodiments of the invention, the power source is a current source, both ends of the current source are electrically connected to both ends of the thermosensitive resistor respectively, and when the resistance value of the thermosensitive resistor changes, the analog voltage signal received by the analog-to-digital converter also changes accordingly. In other embodiments of the invention, the power source is a voltage source, a second resistor is further connected in series between the voltage source and the thermosensitive resistor, the voltage source, the thermosensitive resistor and the second resistor are connected in series. When the resistance value of the thermosensitive resistor changes in response to the temperature of the chip, the voltage between the both ends of the thermosensitive resistor also changes, so that the analog voltage signal received by the analog-to-digital converter also changes accordingly.

Additionally, an embodiment of the present invention further provides a liquid crystal display panel comprising the chip temperature control circuit of the liquid crystal display panel described above.

### Second Embodiment

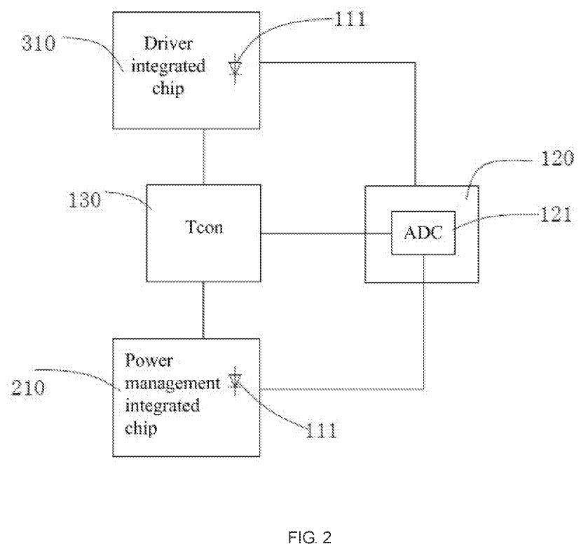

FIG. 2 is a schematic diagram of a chip temperature control circuit of a liquid crystal display panel according to a second embodiment of the present invention. The circuit of FIG. 2 is similar to the circuit of FIG. 1, so that the same reference signs of components represent the same components. The main difference between this embodiment and the first embodiment is that the thermosensitive elements are respectively arranged on the power management integrated chip and the driver integrated chip in this embodiment.

Please refer to FIG. 2, in this embodiment, a chip temperature control circuit of a liquid crystal display panel comprises a power management integrated chip (PMIC) 210, a driver integrated chip 310, a thermosensitive element, an analog-to-digital converter 121, and a timing controller 130.

In this embodiment, the temperatures of the power management integrated chip 210 and the driver integrated chip 310 increase with the increase of power consumption. The driver chip 310 is a source driver integrated chip or a gate driver integrated chip. The thermosensitive elements are respectively arranged on the power management integrated chip 210 and the driver integrated chip 310. The thermosensitive element described herein is a PN junction 111. Both ends of the thermosensitive element on the power management integrated chip 210 and both ends of the thermosensitive element on the driver integrated chip 310 are electrically connected to the analog-to-digital converter 121, and the analog-to-digital converter 121 obtains two analog voltage signals, which correspond to the voltages between the both ends of the thermosensitive element on the power management integrated chip 210 and the voltage between the both ends of the thermosensitive element on the driver integrated chip 310 respectively. Then, the analog-to-digital converter 121 converts the two analog voltage signals into corresponding two digital voltage signals and transmits them to the timing controller 130 respectively, The timing controller 130 obtains a corresponding temperature of the power management integrated chip 210 and a corresponding temperature of the driver integrated chip 310 according to the two digital voltage signals obtained, and the timing controller 130 determines whether the two temperatures respectively exceed the predetermined temperature. In this embodiment, the predetermined temperature corresponding to the power management integrated chip 210 and the predetermined temperature corresponding to the driver integrated chip 310 may be the same or different. When the timing controller 130 determines that as long as one temperature exceeds the predetermined temperature, the timing controller 130 adjusts the corresponding power management integrated chip 210 or the driver integrated chip 310 to reduce power consumption, thereby reducing the temperature of the power management integrated chip 210 or the driver integrated chip 310. By arranging the thermosensitive elements on both the power management integrated chip 210 and the driver integrated chip 310, it is possible to monitor in real time whether the temperatures of the power management integrated chip 210 and the driver integrated chip 310 are too high, and prevent the power management integrated chip 210 and the driver integrated chip 310 from being damaged due to excessive temperature. At the same time, the power consumption of the liquid crystal display panel can be reduced.

It should be noted, each of the embodiments in the specification is described in a progressive manner, and each embodiment focuses on the differences from other embodiments, and the same or similar parts among the various embodiments can be referred to one another. For the embodiment of the device, it is basically similar with the embodiment of method, so the description is simpler, and the related parts can be referred to the description of the embodiment of method.

Above are embodiments of the present invention, which does not limit the scope of the present invention. Any modifications, equivalent replacements or improvements within the spirit and principles of the embodiment described above should be covered by the protected scope of the invention.

What is claimed is:

1. A chip temperature control circuit of a liquid crystal display panel, comprising:
a chip, the temperature of the chip increasing with the increase of power consumption;
a thermosensitive element positioned on the chip, the electrical characteristic of thermosensitive element changing in response to change in the temperature of the chip;
an analog-to-digital converter which is electrically connected to both ends of the thermosensitive element to obtain an analog voltage signal of the thermosensitive element, the analog-to-digital converter converting the analog voltage signal obtained into a corresponding digital voltage signal;
a timing controller which is electrically connected to an output of the analog-to-digital converter and the chip respectively, the timing controller obtaining a corresponding chip temperature according to the digital voltage signal obtained, and the timing controller adjusting the chip to reduce power consumption when the temperature of the chip exceeds a predetermined temperature.

2. The chip temperature control circuit of a liquid crystal display panel according to claim 1, wherein the thermosensitive element is a RN junction, and the voltage between the both ends of PN junction changes in response to change in the temperature of the chip.

3. The chip temperature control circuit of a liquid crystal display panel according to claim 1, wherein the thermosensitive element is a thermosensitive resistor, and the resistance value of thermosensitive resistor changes in response to change in the temperature of the chip.

4. The chip temperature control circuit of a liquid crystal display panel according to claim 3, wherein the thermosensitive element is also electrically connected to a power source to form a closed loop.

5. The chip temperature control circuit of a liquid crystal display panel according to claim 4, wherein the power source is a current source or a voltage source, and the loop also comprises a second resistor connected in series with the thermosensitive element.

6. The chip temperature control circuit of a liquid crystal display panel according to claim 1, wherein a correspondence table indicating a correspondence relationship between a digital voltage signal range and a chip temperature is stored in the timing controller, and the timing controller can specify a corresponding temperature of the chip according to the digital voltage signal received and the correspondence table.

7. The chip temperature control circuit of a liquid crystal display panel according to claim 1, wherein the chip comprises a substrate and an electronic component positioned on the substrate, and the thermosensitive element is positioned on the substrate, and the electronic component is disposed around the thermosensitive element.

8. The chip temperature control circuit of a liquid crystal display panel according to claim 1, wherein the chip is a power management integrated chip, a source driver integrated chip or a gate driver integrated chip; or,
wherein the chip comprises a power management integrated chip and a driver integrated chip, and the thermosensitive elements are respectively arranged on the power management integrated chip and the driver integrated chip, and the thermosensitive elements are electrically connected to the analog-to-digital converter respectively.

9. The chip temperature control circuit of a liquid crystal display panel according to claim 1, wherein the timing controller reduces the operating frequency of the chip when the temperature of the chip exceeds the predetermined temperature.

10. The chip temperature control circuit of a liquid crystal display panel according to claim 1, wherein the chip is positioned outside the array substrate of the liquid crystal display panel, and the chip is electrically connected to a circuit on the array substrate.

11. A liquid crystal display panel comprising the chip temperature control circuit of the liquid crystal display panel according to claim 1.

12. The liquid crystal display panel according to claim 11, wherein the thermosensitive element is a PN junction, and the voltage between the both ends of PN junction changes in response to change in the temperature of the chip.

13. The liquid crystal display panel according to claim 11 wherein the thermosensitive element is a thermosensitive resistor, and the resistance value of thermosensitive resistor changes in response to change in the temperature of the chip.

14. The liquid crystal display panel according to claim 13, wherein the thermosensitive element is also electrically connected to a power source to form a closed loop.

15. The liquid crystal display panel according to claim 14, wherein the power source is a current source or a voltage source, and the loop also comprises a second resistor connected in series with the thermosensitive element.

16. The liquid crystal display panel according to claim 11, wherein a correspondence table indicating a correspondence relationship between a digital voltage signal range and a chip temperature is stored in the timing controller, and the timing controller can specify a corresponding temperature of the chip according to the digital voltage signal received and the correspondence table.

17. The liquid crystal display panel according to claim 11, wherein the chip comprises a substrate and an electronic component positioned on the substrate, and the thermosensitive element is positioned on the substrate, and the electronic component is disposed around the thermosensitive element.

18. The liquid crystal display panel according to claim 11, wherein the chip is a power management integrated chip, a source driver integrated chip or a gate driver integrated chip; or,
wherein the chip comprises a power management integrated chip and a driver integrated chip, and the thermosensitive elements are respectively arranged on the power management integrated chip and the driver integrated chip, and the thermosensitive elements are electrically connected to the analog-to-digital converter respectively.

19. The liquid crystal display panel according to claim 11, wherein the timing controller reduces the operating frequency of the chip when the temperature of the chip exceeds the predetermined temperature.

20. The liquid crystal display panel according to claim 11, wherein the chip is positioned outside the array substrate of the liquid crystal display panel, and the chip is electrically connected to a circuit on the array substrate.
